(19) United States
(12) Patent Application Publication
(10) Pub. No.: US 2025/0305862 A1
(43) Pub. Date: Oct. 2, 2025

(54) ULTRASOUND FLOWMETER AND METHOD FOR OPERATING A FLOWMETER

(71) Applicant: Siemens Aktiengesellschaft, München (DE)

(72) Inventors: Stefan von Dosky, Karlsruhe (DE); Thomas Bierweiler, Stutensee (DE); Stefan Klehr, Rheinzabern (DE); Rafatou Takpara, Haguenau (FR); Fabien Henrot, Auenheim (FR)

(73) Assignee: Siemens Aktiengesellschaft, München (DE)

(21) Appl. No.: 18/621,241

(22) Filed: Mar. 29, 2024

(51) Int. Cl. G01F 1/667; G01F 25/10

(52) U.S. Cl. CPC G01F 1/668; G01F 25/10

(57) ABSTRACT

An ultrasound flowmeter that comprises at least one ultrasound emitter and at least one ultrasound receiver. The ultrasound emitter is configured to emit an ultrasound burst and the ultrasound receiver is configured to capture the ultrasound burst or the reflection of the ultrasound burst. The ultrasound flowmeter further comprises a control unit that is configured to determine a reception quality parameter based on the captured ultrasound burst or the captured reflection of the ultrasound burst, respectively. The ultrasound flowmeter further comprises a driving means for altering a distance between the ultrasound emitter and the ultrasound receiver. The method for operating the flowmeter comprises determining the at least one reception quality parameter and altering the distance between the ultrasound emitter and the ultrasound receiver until the reception quality parameter reaches an optimized value.

### TECHNICAL FIELD

The present disclosure relates to an ultrasound flowmeter and a method for operating an ultrasound flowmeter. Furthermore, the present disclosure also relates to a computer program product for performing such a method and a control unit that is configured to control an ultrasound flowmeter. Still further, the present disclosure relates to a method for simulating an operational behavior of an ultrasound flowmeter and a simulation program product that is configured to perform such a method.

### BACKGROUND

US 2008/0216555 A1 discloses a method for calibrating ultrasound clamp-on flowmeters, in which two sound transducers are arranged acoustically opposing. A first sound transit time is measured at a first distance between the two sound transducers. Subsequently, the distance between the two sound transducers is changed to a second distance and a second sound transit time is measured at the second distance. Based on that, an acoustic calibration factor is calculated.

Ultrasound flowmeters are used in a variety of industrial applications for monitoring processes. Clamp on ultrasound flowmeters usually require significant time and effort from a skilled technician to install them precisely. Furthermore, maintenance and repair of ultrasound flowmeters also requires significant effort and expertise. Still further, the operation of an ultrasound flowmeter requires significant amounts of energy. Thus, there is demand for an ultrasound flowmeter that offers an improvement in at least one of these aspects.

### SUMMARY

The object described above is achieved by an ultrasound flowmeter which comprises at least one ultrasound emitter and at least one ultrasound receiver. The ultrasound emitter is configured to emit an ultrasound burst and the ultrasound receiver is configured to capture, i.e. to receive, the ultrasound burst or a reflection of the ultrasound burst. Furthermore, the ultrasound receiver is connected to a control unit. The control unit may be configured to receive signals from the ultrasound receiver which represent the captured ultrasound burst or the reflection of the ultrasound burst, respectively. According to the present disclosure, the control unit is configured to determine a quality parameter based on the captured ultrasound burst or the captured reflection of the ultrasound burst, respectively. At least one of the ultrasound emitter and the ultrasound receiver is connected to a driving means for altering a distance between the ultrasound emitter and the ultrasound receiver. The driving means is configured to cause at least one of the ultrasound emitter and the ultrasound receiver to move depending on the reception quality parameter.

In addition to that, the object described above is also achieved by a method for operating an ultrasound flowmeter. The ultrasound flowmeter comprises at least one ultrasound emitter, at least one ultrasound receiver and at least one driving means for altering a distance between the ultrasound emitter and the ultrasound receiver. Furthermore, the ultrasound flowmeter comprises a control unit that is connected to the at least one ultrasound emitter, the at least one ultrasound receiver and the driving means. The method comprises a first during which the ultrasound flowmeter is mounted to a wall of a pipe and during which at least one of the ultrasound emitter and the ultrasound receiver is put into a starting position.

During a second step of the method, an ultrasound burst is emitted from the ultrasound emitter and the ultrasound burst or a reflection of the ultrasound burst is captured at the ultrasound receiver. Additionally, a reception quality parameter for the captured ultrasound burst or the captured reflection of the ultrasound burst is determined, respectively. The method also comprises a third step during which the distance between the ultrasound emitter and the ultrasound receiver by actuating the driving means. In the method according to the present disclosure, the steps of emitting the ultrasound burst, capturing the ultrasound burst or the reflection of the ultrasound burst respectively, determining the reception quality parameter and altering the distance between the ultrasound emitter and the ultrasound receiver are repeated until the reception quality parameter reaches an optimized value.

The object identified above is also achieved by a computer program product that is stored in a non-transitory memory. The computer program product comprises machine-readable program code which is configured to perform steps when it is loaded into the memory of a computer. A first step performed by the machine/-readable program code comprises actuating a driving means to cause at least one of an ultrasound emitter and an ultrasound receiver to assume a starting position. A second step comprises instructing the ultrasound emitter to emit an ultrasound burst and instructing the ultrasound receiver to capture the ultrasound burst or a reflection of the ultrasound burst. The second step also comprises determining a reception quality parameter for the captured ultrasound burst or the captured reflection of the ultrasound burst, respectively.

In addition to that, a third step performed through the machine-readable program code comprises actuating the driving means to alter the distance between the ultrasound emitter and the ultrasound receiver. The steps of instructing the ultrasound emitter to emit the ultrasound burst, instructing the ultrasound receiver to capture the reflection of the ultrasound burst, determining the reception quality parameter and instructing the driving means to alter the distance between the ultrasound emitter and the ultrasound receiver are repeated until the reception quality parameter reaches an optimized value.

### BRIEF DESCRIPTION OF THE DRAWINGS

In the following, the present disclosure is described in more detail in several figures. The figures are to be construed as mutually complementary. Particularly, identical numerals are to be construed as having the same technical meaning. The features of the embodiments shown in the figures may be combined with each other. Additionally, the features of the embodiments shown in the figures may also be combined with the embodiments outlined above and below. In particular, the figures show:

FIG. 1 illustrates an embodiment of the disclosed ultrasound flowmeter in longitudinal section that is configured to perform a first embodiment of the disclosed method for operating an ultrasound flowmeter;

FIG. 2 a schematic overview of a stage of a second embodiment of the disclosed method for operating an ultrasound flowmeter;

FIG. 3 a flowchart of a third embodiment of the disclosed method for operating an ultrasound flowmeter;

FIG. 4 a flowchart of an embodiment of the disclosed method for simulating an operational behavior of an ultrasound flowmeter;

### DETAILED DESCRIPTION

The disclosed ultrasound flowmeter comprises at least one ultrasound emitter and at least one ultrasound receiver. The ultrasound emitter is configured to emit an ultrasound burst and the ultrasound receiver is configured to receive, i.e. to capture, the ultrasound burst or a reflection of the ultrasound burst. Depending on the relative arrangement of the ultrasound emitter and the ultrasound receiver, there may be a line of sight between the ultrasound emitter and the ultrasound receiver, enabling the ultrasound receiver to receive the ultrasound burst directly. Alternatively, the ultrasound burst may be reflected at least once before it reaches the ultrasound receiver, thus forming the reflection of the ultrasound burst. The at least one ultrasound emitter and the at least one ultrasound receiver may be arranged along a pipe to which the disclosed ultrasound flowmeter may be attached.

Furthermore, the ultrasound emitter and the ultrasound receiver may be arranged on the same side of the pipe or on substantially opposing sides of the pipe. At least one of the ultrasound emitter and the ultrasound receiver may be embodied as an ultrasound transceiver. The at least one ultrasound emitter may be attached to the pipe as to emit the ultrasound burst through a pipe wall and into a fluid inside the pipe. The ultrasound burst may be reflected at least once at the pipe wall. Furthermore, the ultrasound flowmeter comprises a control unit that is connected to the at least one ultrasound receiver. The control unit may be configured to receive signals form the at least one ultrasound receiver which represent the ultrasound burst or the reflected ultrasound burst, respectively. The control unit is further configured to determine a reception quality parameter based on the captured ultrasound burst or the captured reflection of the ultrasound burst, respectively.

Still further, at least one of the ultrasound emitter and the ultrasound receiver is connected to a driving means for altering the distance between the at least one ultrasound emitter and the at least one ultrasound receiver. The distance between the at least one ultrasound emitter and the at least one ultrasound receiver may be an axial distance along a main axis of the pipe to which the ultrasound flowmeter may be attached. The control unit is configured to cause at least one of the ultrasound emitter and the ultrasound receiver to move depending on the reception quality parameter. When at least one of the ultrasound emitter and the ultrasound receiver is moved, the distance between them may change.

The reception quality parameter may be a physical quantity of the ultrasound burst or the reflection of the ultrasound burst that is immediately captured by the at least one ultrasound receiver or an artificial quantity that is at least partially derivable from such a physical quantity. With identical ultrasound bursts, the reception quality parameter varies depending on the distance between the at least one ultrasound emitter and the at least one ultrasound emitter. Thus, the reception quality parameter is a predictor for a measurement precision when the disclosed ultrasound flowmeter is utilized for measuring the flow of the fluid inside the pipe. The distance between the at least one ultrasound emitter and the at least one ultrasound receiver may be altered in incremental steps to determine a distance between them that offers an optimal signal quality, thus allowing for a precise flow measurement.

The at least one ultrasound emitter, the at least one ultrasound receiver and the driving means may be controlled in an automated manner. Consequently, the disclosed ultrasound flowmeter is suitable for an automated self-calibration. In turn, that allows for installing the disclosed ultrasound flowmeter to a wide variety of pipe with different diameters and wall thicknesses with only limited amount of interaction with a user. As a consequence, the disclosed ultrasound flowmeter is less susceptible to calibration errors. At least the third step of the disclosed method may be a computer-implemented step.

In an embodiment of the disclosed ultrasound flowmeter, the reception quality parameter may comprise at least one of am amplitude of the ultrasound burst or the reflection of the ultrasound burst, respectively, a parameter of a frequency component of the ultrasound burst or the reflection of the ultrasound burst respectively and a signal-to-noise ratio of the ultrasound burst or the reflection of the ultrasound burst respectively. The amplitude may reflect an intensity of the received ultrasound burst or the reflection of the ultrasound burst, respectively. The parameter of a frequency component may be a parameter derived from a Fourier transformation of the ultrasound burst or the reflection of the ultrasound burst, respectively.

Without limitation, the reception quality parameter may comprise any further quantity that reflects how well-readable the ultrasound burst or the reflection of the ultrasound burst may be at the at least one ultrasound receiver, respectively. A broad variety of analysis methods are available for evaluating the ultrasound burst or the reflection of the ultrasound burst respectively which may be implemented with a reduced number of computational operations. Thus, the disclosed ultrasound flowmeter may be configured to self-adjust with reduced energy consumption. That allows for using the disclosed ultrasound flowmeter being battery-powered for an extended period of time.

In another embodiment of the disclosed ultrasound flowmeter, the ultrasound burst may comprise a selectable frequency composition. The ultrasound burst may comprise at least one marker frequency or a frequency pattern that is detectable at the ultrasound receiver. The frequency composition may be embodied as a frequency sweep which allows for a precise evaluation of the ultrasound burst or the reflection of the ultrasound burst, respectively. The frequency composition of the ultrasound burst may be predefined, may be selected by a user or by an algorithm, for example an artificial intelligence. Furthermore, an ultrasound burst may be adaptable depending on a reception quality parameter derived from a previous ultrasound burst or a reflection of a previous ultrasound burst. The control unit may be configured to perform such an adaption of the ultrasound burst. With such an adaption, the disclosed ultrasound flowmeter is capable of automatically optimizing its self-calibration capabilities.

Additionally, the control unit of the disclosed ultrasound flowmeter may be configured to detect an optimized value of the reception quality parameter. The control unit may further be configured to control the driving means to adjust the distance between the at least one ultrasound emitter and the at least one ultrasound receiver to a value corresponding to the detected optimized value. The optimized value may be a maximum value of the reception quality parameter or a threshold value. Furthermore, the optimized value may be a value that allows for a signal strength that is sufficient for operating the ultrasound flowmeter. To detect the optimized value, at least one of the ultrasound emitter and the ultrasound receiver may be moved through at least a portion of the range of obtainable distances between the ultrasound emitter and the ultrasound receiver, wherein at least one reception quality parameter is determined at each assumed distance. Thus, the optimized value and the corresponding optimized distance between the ultrasound emitter and the ultrasound receiver may be determined both quickly and precisely.

Moreover, the control unit may be configured to compare a determined value of the reception quality parameter to a previously determined value of the reception quality parameter. The value of the reception quality parameter may be determined after the ultrasound flowmeter is calibrated. To that end, an ultrasound burst may be emitted. By comparing a value of the reception quality parameter to a previous value, a deterioration at least one of the disclosed ultrasound flowmeter and the pipe may be detected. Such a deterioration may be caused by a loosening attachment of the ultrasound flowmeter or wear of the pipe wall respectively. Correspondingly, the steps outlined above may be repeated to automatically re-calibrate the disclosed ultrasound flowmeter. Thus, the disclosed ultrasound flowmeter may comprise at least one of a self-monitoring function and a pipe monitoring function. To that end, the control unit may comprise an algorithm, for example an artificial intelligence, that is configured to distinguish between different types of deterioration. Such an artificial intelligence may be a neural network.

The disclosed ultrasound flowmeter may comprise an energy storage that is configured to run at least the ultrasound emitter, the ultrasound receiver, the control unit and the driving means. The energy storage may be embodied as a battery. Particularly, the energy storage may be configured to calibrate the ultrasound flowmeter at least one and to run at least 10,000 flow measurement operations. Such an ultrasound flowmeter offers a sufficiently long product life cycle for a wide variety of industrial applications.

Furthermore, the control unit of the disclosed ultrasound flowmeter may be a local control unit or a remote control unit that is connected to the ultrasound flowmeter through a communication-capable data connection. The local control unit may be integrated into a housing of the ultrasound flowmeter or may be attached to it. The local control unit may be a chip or a controller that is at least functionally integrated into at portion of the ultrasound flowmeter that is attachable to the pipe. The communication-capable data connection to the remote control unit may be at least one of an industrial fieldbus, a computer-network connection or a wireless connection, for example WLAN, Bluetooth, ZigBee, LoRaWAN, 4G, 5G or 6G. The remote control unit may be at least one of a Programmable Logic Controller, a computer or a computer cloud.

The self-calibration functionality of the disclosed ultrasound flowmeter may readily be implemented in the local control unit, thus reducing the amount of data traffic to and from the ultrasound flowmeter. If a remote control unit is utilized, the self-calibration functionality may be centrally provided, thus facilitating the operation of a large number of such ultrasound flowmeters. As a consequence, the disclosed ultrasound flowmeter may be adapted to a broad range of applications.

In another embodiment of the disclosed ultrasound flowmeter, the control unit may be configured to determine a flow of the fluid in the pipe, to which the ultrasound flowmeter is connected or attached to. To that end, the control unit may be configured to store and run a computer program that is configured to receive measuring values from at least one ultrasound receiver and to determine the flow of the fluid at least partly based on the received measuring values. Thus, the self-calibration functionality of the disclosed ultrasound flowmeter may be integrated into the control unit which performs the flow measuring functionality. Since the self-calibration functionality only required a reduced amount of computing power, it may be implemented alongside the flow measuring functionality on the same control unit. Thus, the disclosed ultrasound flowmeter provides the described self-calibration functionality in a cost-efficient manner.

In yet another embodiment of the disclosed ultrasound flowmeter, the ultrasound flowmeter is connected to a temperature sensor. The temperature sensor is configured to detect temperature of the fluid. The temperature sensor may be one of an invasive temperature sensor and a noninvasive temperature sensor. Furthermore, the temperature sensor may be connected to the control unit, which may be configured to receive measuring values of the temperature of the fluid. In addition to that, the control unit may be configured to perform a temperature compensation for at least one of the self-calibration functionality and the flow measuring functionality. The control unit of the disclosed ultrasound flowmeter may be configured to initiate a re-calibration when a difference between the temperature of the fluid in the pipe and a reference temperature exceeds a threshold value. In addition to that, the control unit may be configured to detect a deteriorating calibration of the ultrasound flowmeter and to correlate the deteriorating calibration to a change of the temperature of the fluid. Thus, the control unit may be configured to determine if the change of the temperature of the fluid is a cause for the deteriorating calibration or to which extend. As a consequence, the control unit may be configured to detect an additional cause for a deterioration of the calibration of the ultrasound flowmeter.

The object outlined above is also achieved by a disclosed method for operation an ultrasound flowmeter. The ultrasound flowmeter comprises at least one ultrasound emitter and at least one ultrasound receiver. At least one of the ultrasound emitter and the ultrasound receiver may each be embodied as an ultrasound transceiver. At least one of the ultrasound emitter and the ultrasound receiver are moveable to adjust a distance between them. The ultrasound flowmeter further comprises at least one driving means for altering the distance between the ultrasound emitter and the ultrasound receiver. Additionally, the ultrasound flowmeter comprises a control unit that is connected to the ultrasound emitter, the ultrasound receiver and the driving means.

The control unit may be connected to the ultrasound emitter, the ultrasound receiver and the driving means each direct or indirectly. The disclosed method comprises a first step in which the ultrasound flowmeter is mounted to a wall of a pipe. Furthermore, at least one of the ultrasound emitter and the ultrasound receiver is put into a starting position. In second step of the method, an ultrasound burst is emitted from the ultrasound emitter. The ultrasound burst may be substantially diagonally emitted into the pipe wall. A reflection of the ultrasound burst is received at the ultrasound receiver. Alternatively, the ultrasound burst may be directly received by the ultrasound receiver. Furthermore, a reception quality parameter may be determined for the captured ultrasound burst or the captured reflection of the ultrasound burst, respectively. The quality parameter may be determined by the control unit of the ultrasound flowmeter. The disclosed method also comprises a third step in which the distance between the ultrasound emitter and the ultrasound receiver is altered by actuating the driving means.

In the disclosed method, the steps of emitting the ultrasound burst, capturing the ultrasound burst or the reflection of the ultrasound burst respectively, determining the reception quality parameter and altering the distance between the ultrasound emitter and the ultrasound receiver are repeated until the reception quality parameter reaches an optimized value. The optimized value may be a maximum or a value that exceeds a predefined threshold value. Furthermore, the optimized value may be a value that reflects a signal strength that is sufficient for an operation of the ultrasound flowmeter. When the optimized value for the distance between the ultrasound emitter and the ultrasound receiver is determined based on the steps outlined above, at least one of the ultrasound emitter and the ultrasound receiver may be held in their respective positions.

The steps mentioned above allow for finding an optimized adjustment for the ultrasound flowmeter, which also allows for a precise flow measurement. The method may be performed for calibrating the ultrasound flowmeter when it is being commissioned. Alternatively, the disclosed method may be utilized for re-calibrating the ultrasound flowmeter during normal operation. Among others, the disclosed method is based on the surprising finding, it allows for reliably finding an optimized calibration of the ultrasound flowmeter in an automated manner. The disclosed method may be performed with an ultrasound flowmeter according to one of the embodiments outlined above. Therefore, the features of the disclosed ultrasound flowmeter apply to the disclosed method accordingly.

In an embodiment of the disclosed method, the reception quality parameter comprises at least one of an amplitude of the captured ultrasound burst or the reflection of the ultrasound burst respectively, a parameter of a frequency component of the captured ultrasound burst the reflection of the ultrasound burst, and a signal-to-noise ratio of the captured ultrasound burst or the reflection of the ultrasound burst, respectively. Such reception quality parameters may be precisely measured in an automated manner. Particularly, such reception quality parameters may reflect the precision that is obtainable for flow measurements with the at least one ultrasound emitter and the at least one ultrasound receiver. Consequently, the disclosed method may be implemented based on a variety of reception quality parameters, which allow for an optimized calibration or re-calibration.

In yet another embodiment, the disclosed method is performed independent of at least one of a diameter of the pipe, a wall thickness of the pipe and a material of the pipe. Thus, the disclosed method may be performed without utilizing at least one of the diameter of the pipe, the wall thickness of the pipe, the material of the pipe and a quantity derived from at least one of them as a parameter, especially as an input parameter. The disclosed method only requires a reduced amount of input data. Consequently, the disclosed method is robust and only requires reduced knowledge and experience of a user who is installing the ultrasound flowmeter at the pipe. The disclosed method may be implemented as a separate function for a variety of ultrasound flowmeters. Effectively, the disclosed method is only limited by the fact if the ultrasound flowmeter can be attached to the pipe at all. Thus, the disclosed method may be used in a multitude of applications, especially industrial applications.

Furthermore, the disclosed method may comprise a fourth step in which a temperature change of the fluid in the pipe is detected with a temperature sensor. The fourth step also comprises determining if the detected temperature change exceeds a predefined threshold. The fourth step may be performed as a computer-implemented step, for example by a computer program product that is run on the control unit of the ultrasound flowmeter. The disclosed method may further comprise a fifth step in which a re-calibration of the flowmeter is performed. The re-calibration is performed by emitting an ultrasound burst from the ultrasound emitter and by capturing the ultrasound burst or a reflection of the ultrasound burst at the ultrasound receiver, respectively. The re-calibration also comprises determining a reception quality parameter for the captured ultrasound burst or the captured reflection of the ultrasound burst, respectively, and altering the distance between the ultrasound emitter and the ultrasound receiver by actuating the driving means.

The fifth step may be also performed based on the computer program product that is run on the control unit of the ultrasound flowmeter. The steps of emitting the ultrasound burst, capturing the ultrasound burst or the reflection of the ultrasound burst, respectively, determining the reception quality parameter and altering the distance between the ultrasound emitter and the ultrasound receiver are repeated until the reception quality parameter reaches an optimized value. The optimized value may be a maximum or a value that exceeds a threshold value. Based on the fourth and fifth step, the underlying ultrasound flowmeter may be re-calibrated during its operation. The disclosed method may be automatically performed triggered by a detected event or a schedule to maintain an optimal calibration. That allows for operating the ultrasound flowmeter, and in turn an industrial process associated with the ultrasound flowmeter, at an increased efficiency without interference by a user. Thus, the disclosed method enhances the cost-effectiveness of the associated industrial process.

In addition to that, the disclosed method may be performed while the fluid is flowing through the pipe. The fluid may be flowing through the pipe between the third and fourth step. When the fluid is flowing through the pipe, the ultrasound flowmeter may be operated to measure the flow of the fluid in the pipe. The flow of the fluid may be measured by emitting ultrasound pulses from the ultrasound emitter, receiving reflections of the ultrasound pulses at the ultrasound receiver and by evaluating the received reflections of the ultrasound pulses. The measuring of the flow of the fluid may be performed based on the computer program product that is run on the control unit of the ultrasound flowmeter. The disclosed method may also be performed while the ultrasound flowmeter is re-calibrated as outlined above. Consequently, the re-calibration of the ultrasound flowmeter does not necessitate an interruption of the normal measuring operation of the ultrasound flowmeter. The disclosed method allows for an increased availability of the ultrasound flowmeter.

The object described above is also achieved by the disclosed computer program product that is configured to be stored in a non-transitory memory. The non-transitory memory may be a magnetic memory like a USB stick or a hard disk, an optical memory like a CD-ROM or any other kind similar kind of memory. The computer program product comprises machine-readable program code. The machine-readable program code is configured to perform steps when it is loaded into the memory of a computer. The steps comprise a first step in which a driving means is actuated to at least one of an ultrasound emitter, and an ultrasound receiver assume a starting position.

The ultrasound emitter and the ultrasound receiver may be parts of an ultrasound flowmeter that is attached to a pipe. The steps also comprise a second step in which the ultrasound emitter is instructed to emit an ultrasound burst. Furthermore, the ultrasound receiver is instructed to capture the ultrasound burst or a reflection of the ultrasound burst, respectively. Still further, a reception quality parameter is determined during the second step. The reception quality parameter is determined based on the captured ultrasound burst or the captured reflection of the ultrasound burst, respectively. The program code is also configured to perform a third step in which the driving means is actuated to alter to distance between the ultrasound emitter and the ultrasound receiver.

The computer program product, and thus also the program code, is further configured to repeat the steps outlined above until the reception quality parameter reaches an optimized value. The optimized value may be a maximum or a value that exceeds a predefined threshold value. The computer program product is configured to determine the distance between the ultrasound emitter and the ultrasound detector that offers improved reception quality for ultrasound burst or ultrasound pulses for measuring a flow of a fluid in a pipe to which the ultrasound flowmeter is attached. With the at least one reception quality parameter, the disclosed computer program product is simple to implement and may be run on a hardware platform with reduced computing capabilities.

Therefore, the computer program product may be run on a control unit that belongs to the ultrasound flowmeter. In addition to that, the installation of such an ultrasound flowmeter is simplified with the disclosed computer program product. The disclosed computer program product may be configured to be executed on an ultrasound flowmeter as described above. The features of the disclosed ultrasound flowmeter also apply to the disclosed computer program product. Furthermore, the disclosed computer program product may be configured to perform at least one of the embodiments of the disclosed method, as outlined above. The computer program product may at least be partially embodied as software or at least hardwired, for example as an integrated circuit or a chip. Still further, the computer program product may be embodied as a monolithic program, being configured to be run on a single hardware platform. Alternatively, the disclosed computer program product may be embodied as a set of partial programs that run on separate hardware platforms and which are configured to interact with each other through a data connection to provide the functionality described above.

In addition to that, the object outlined above is also achieved by the disclosed control unit which is configured to control an operation of an ultrasound flowmeter. The control unit comprises a memory and a processor, which are configured to execute a machine-readable program code of a computer program product. The control unit further comprises at least one communication interface that is configured for sending instructions to at least one of an ultrasound emitter, an ultrasound receiver and a driving means. In the disclosed control unit, the computer program product stored in it may be a computer program product according to one of the embodiments described above. The features of the computer program product, and in turn the disclosed method and the disclosed ultrasound flowmeter, also apply to the disclosed control unit. Since the underlying method only requires a reduced amount of computing power, the disclosed control unit is suitable to provide the described calibration functionality in a cost-efficient manner. With its reduced demand for computing. Furthermore, the control unit may be battery-powered.

Moreover, the object described above is also achieved by the disclosed method for simulating an operational behavior of an ultrasound flowmeter. The method comprises a first step in which a set of data points is provided that mirror the functioning of at least a portion of the ultrasound flowmeter that is to be simulated. The data points may be a digital model and may be part of a digital twin. The data points may mirror the physical design of at least one of the ultrasound flowmeter, a pipe to which the ultrasound flowmeter is attached, and a fluid that is contained in the pipe. Alternatively, the data points may also comprise a mathematical model that emulates at least a functionality of any component of the emulated ultrasound flowmeter. In a second step of the disclosed method, at least one operational parameter is set. The at least one operational parameter may be any parameter that characterizes the operational state of the ultrasound flowmeter that is to be simulated.

The at least one operational parameter may comprise a structure of an ultrasound burst, a flow rate of the fluid in the pipe, a temperature of the fluid in the pipe, an ambient temperature, and a composition of the fluid in the pipe. Furthermore, the at least one operational parameter may be set by at least one of a user and an algorithm that comprises artificial intelligence. In a third step of the disclosed method, a simulation program product is executed that is configured to emulate the operational behavior of the ultrasound flowmeter based on the set of data points and the at least one operational parameter. Based on the set of data points and the at least one operational parameter, at least one performance parameter is determined through the simulation program product. The performance parameter may be any quantity that characterizes the operation of the emulated ultrasound flowmeter. The performance parameter may be at least one of a determined flow rate of the fluid in the pipe, a difference between the determined flow rate of the fluid and the flow rate defined as an operational parameter, and a signal parameter derived from an emulated received ultrasound burst or an emulated received reflection at the ultrasound receiver, i.e. the emulated ultrasound receiver, respectively.

The disclosed method further comprises a fourth step, in which the at least one performance parameter is output to at least one of a user and a data interface. The data interface may be configured to exchange simulations results from the simulation program product with additional simulation-oriented computer program product. The data interface may further be embodied as a so-called Application Programming Interface, or also known as an API. According to the disclosed method, the ultrasound flowmeter that is emulated is embodied according to one of the embodiments outlined above. Thus, the features of the disclosed ultrasound flowmeter also apply to the disclosed method for simulation an operational behavior. Correspondingly, the features of the disclosed method for operating an ultrasound flowmeter also apply to the disclosed method for simulating an operational behavior.

The simulation program product may comprise a digital twin of the simulated ultrasound flowmeter. The simulation program product may be embodied as a digital twin pursuant to US 2017/0286572 A1. The contents of US 2017/0286572 A1 are hereby incorporated into the present application by reference. The simulation program product may further comprise a physics module that is configured to simulate a behavior of at least one of the components of the ultrasound flowmeter. The physics module may be configured to calculate the acoustic effects of at least one of the pipe wall and the fluid on the ultrasound burst and the reflection of the ultrasound burst as it propagates from the ultrasound emitter to the ultrasound receiver. The physics module may also be configured to emulate the capturing characteristics of the ultrasound receiver. Among others, the disclosed method is based on the finding that the acoustic effects of walls of pipes and fluids may be precisely simulated even with reduced computing power. That includes a distorting and dissipating effect of the pipe wall and of the fluid onto the ultrasound burst and its reflection. Such distorting and dissipating effects may also be caused by reflecting the ultrasound burst and by its propagation through the fluid. Consequently, reception quality parameters of the ultrasound flowmeter may be predicted by the simulation program product.

Based on the disclosed method for simulating an operational behavior, the quality of the calibration of the ultrasound flowmeter may be automatically monitored. Since the disclosed method for simulating an operational behavior only requires a relative small amount of computing power, the disclosed method may be configured to provide real-time monitoring of the physical ultrasound flowmeters. The simulation program product may be configured to be stored on a non-transitory memory and may comprise program code that is configured to perform at least one of the steps described above, when it is loaded into a memory of a computer.

In addition to that, the underlying object is also achieved by the disclosed simulation program product that is configured for simulating an operational behavior of an ultrasound flowmeter. The operational behavior is simulated through a method for simulating an operational behavior of an ultrasound flowmeter as outlined above. The simulation program product may be configured to perform at least the third step of the corresponding method. The features of the disclosed method for simulating an operational behavior as described above also apply to the disclosed simulation program product accordingly.

In an embodiment of the disclosed simulation program product, the simulation program product comprises a data interface that is configured to connect the simulation program product to at least one of an ultrasound emitter, an ultrasound receiver, and a driving means of the ultrasound flowmeter that that is mirrored in the set of data points. The simulation program product may be connected to the simulated ultrasound flowmeter to monitor at least one of the reception quality parameters present there. Such a reception quality parameter derived from physical measurements may be compared to a corresponding simulated reception quality parameter. Based on such a comparison, and undue deterioration of the calibration of the physical ultrasound flowmeter may be detected and checked for plausibility. An undue deterioration of the calibration may be caused by a defect component of the ultrasound flowmeter. Furthermore, the simulation program product may be configured to predict when the physical ultrasound flowmeter is to be re-calibrated. Still further, the simulation program product may be configured to detect a defect or deteriorated component of the ultrasound flowmeter by comparing a measured reception quality parameter with a simulated reception quality parameter.

In yet another embodiment of the disclosed simulation program product, the simulation program product may comprise a further data interface that is configured to receive data from at least one of the ultrasound emitter, the ultrasound receiver and the driving means of the physical ultrasound flowmeter. The additional data interface may also be embodied as an Application Programming Interface, or briefly API.

Turning to the figures, the disclosed ultrasound flowmeter, the disclosed method for operating an ultrasound flowmeter, the disclosed computer program product, the disclosed control unit, the disclosed method for simulating an operational behavior of an ultrasound flowmeter and the disclosed simulation program product are shown in more detail.

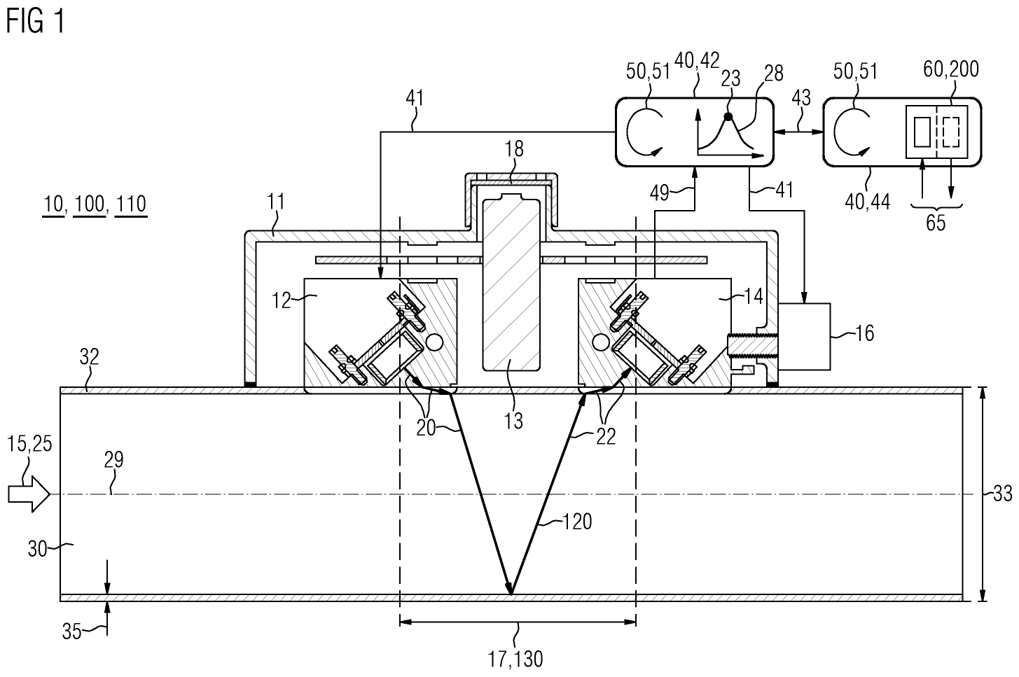

FIG. 1 shows an embodiment of the disclosed ultrasound flowmeter 10 which is mounted on a pipe 30. The pipe 30 has a pipe wall 32 with a wall thickness 35 and a pipe diameter 33, which define an interior of the pipe 30. The pipe 30 is configured to guide a fluid 15, which may flow at a variable flow rate 25. The ultrasound flowmeter 10 is configured to measure the flow rate 25 of the fluid 15 in the pipe 30. The ultrasound flowmeter 10 comprises a housing 11 in which an ultrasound emitter 12 and an ultrasound receiver 14 are accommodated. Each of the ultrasound emitter 12 and the ultrasound receiver 14 may be embodied as ultrasound transceivers, which are configured to emit and receive ultrasound pulses and ultrasound bursts 20. With the ultrasound flowmeter 10 being attached to the pipe 10, the ultrasound emitter 12 is in contact with the pipe wall 32 and is arranged to emit an ultrasound burst 20 into the pipe wall 32. The ultrasound burst 20 is deflected as it penetrates the pipe wall 32 and further deflected as it enters the interior of the pipe 30, which is filled with the fluid 15.

The ultrasound burst 20 is substantially reflected at a section of the pipe wall 32 that is arranged substantially opposite the ultrasound emitter 12. The reflection 22 of the ultrasound burst 20 reaches the pipe wall 32, where is it deflected. The reflection 22 is deflected once more as it reaches the ultrasound receiver 14. The ultrasound receiver 14 is mechanically coupled to a driving means 16, which may be an electric motor. The driving means 16 and the ultrasound receiver 14 are configured to alter a distance 17 between the ultrasound emitter 12 and the ultrasound receiver 14. The distance 17 between the ultrasound emitter 12 and the ultrasound receiver 14 is defined along a pipe axis 29 that substantially extends along the pipe 30 in a section where the ultrasound flowmeter 10 is mounted.

Furthermore, the ultrasound flowmeter 10 comprises an energy storage 13 that may be embodied as a battery. The energy storage 13 is configured to power at least the ultrasound emitter 12, the ultrasound receiver 14 and the driving means 16 of the ultrasound flowmeter 10. In addition to that, the ultrasound flowmeter 10 comprises an indicating means 18 which is embodied as an LED. The indicating means 18 is configured to output at least a warning to a user of the ultrasound flowmeter 10. Still further, the ultrasound flowmeter 10 comprises a control unit 30, that is embodied as a local control unit 42. Through a data connection 43, which may be an industrial fieldbus connection or a wireless connection, the local control unit 42 is connected to a remote control unit 44. Partial programs 51, which are part of a computer program product are stored on the local control unit 42 and the remote control unit 44. The partial programs 51 are configured to interact with each other through the data connection 43 between the local control unit 42 and the remote control unit 44. The computer program product 50 and the local control unit 42 are configured to send instructions 41 to the ultrasound emitter 12 and the driving means 16. The computer program product 50 and the local control unit 42 are further configured to receive data from the ultrasound receiver 14. Furthermore, the computer program product 51 comprises program code that is configured to perform a first embodiment of the disclosed method 100.

The disclosed method 100 is configured to calibrate the ultrasound flowmeter 10 when it is installed and may be performed while the fluid 15 flows through the pipe 30. In a first step 110 of the disclosed method 100, the ultrasound flowmeter 10 is mounted to the pipe wall 32. Furthermore, the ultrasound receiver 14 is moved into a starting position, which may be one of the extreme positions of the ultrasound receiver 14. Such a starting position may be a position at which the distance 17 between the ultrasound emitter 12 and the ultrasound receiver 14 is at is maximum or minimum. In a second step 120, the ultrasound emitter 12 emits an ultrasound burst 20 which is defined through the computer program product 50. The emitted ultrasound burst 20 penetrates the pipe wall 32, enters the interior of the pipe 30 and travels to a section of the pipe that is substantially opposite to the ultrasound emitter 12. There, the pipe wall 32 reflects the ultrasound burst 20, thus forming a reflection 22 of the ultrasound burst 20.

The ultrasound receiver 14 receives the reflection 22 of the ultrasound burst 20 and captures at least one physical quantity of the reflection 22. The ultrasound receiver 14 send the at least one captured physical quantity of the reflection 22 as data 49 to the local control unit 42. Based on the data 49 from the ultrasound receiver 14, the local control unit 30 utilizes the computer program product 50 to determine at least one reception quality parameter 28. The determined reception quality parameter 28 is at least temporarily stored on at least one of the local control unit 42 and the remote control unit 44. In a third step 130 of the disclosed method 100 for operating the ultrasound flowmeter 10, the distance 17 between the ultrasound emitter 12 and the ultrasound receiver 14 is altering. To that end, the local control unit 42 transmits an instruction 41 to the driving means 16, which moves the ultrasound receiver 14 closer to the ultrasound emitter 12 or further away from the ultrasound emitter 12.

The steps, in which the ultrasound emitter 12 emits an ultrasound burst 20, the ultrasound receiver 14 receives a reflection 22 of the corresponding ultrasound burst 20, the local control unit 42 determines at least one reception quality parameter 28 of the received reflection, and the driving means 16 alters the distance 17 between the ultrasound emitter 12 and the ultrasound receiver 14 are repeated. These steps are repeated until the prediction quality parameter 28 reaches an optimized value 23. In the embodiment according to FIG. 1, the optimized value 23 is a maximum of the reception quality parameter 28. The driving means 16 may be actuated to increase or to decrease the distance 17 between the ultrasound emitter 12 and the ultrasound receiver 14 in different iterations of the outlined steps to find the optimized value 23 in an iterative manner. Once the distance 17 is found at which the reception quality parameter 28 reaches its optimized value 23, the ultrasound receiver 14 is held at the corresponding position. At that position, ultrasound pulses from the ultrasound emitter 12 will be received at the ultrasound receiver 14 at an enhanced level of signal quality, which in turn allows for a precise measurement of the flow rate 25 of the fluid 15 in the pipe 30.

The method 100 described above may be performed separately or while the ultrasound flowmeter 10 performs a measuring operation. Consequently, the disclosed method 100 is suitable for both an initial calibration of the ultrasound flowmeter 10 and a re-calibration of the ultrasound flowmeter 10. The local control unit 32, and thus also the computer program product 50, initiates such a re-calibration based on the disclosed method when the reception quality parameter 28 falls below a predefined threshold. To that end, the local control unit 42 may instruct the ultrasound emitter 12 to emit an ultrasound burst 20 so the local control unit 42 may determine the reception quality parameter 28 during the measuring operation of the ultrasound flowmeter 10. Consequently, the disclosed method 100 may be utilized to monitor a calibration quality of the ultrasound flowmeter 10 and to automatically perform a re-calibration of the ultrasound flowmeter 10.

Furthermore, s simulation program product 60 is stored on the remote control unit 44, the simulation program product 60 being configured to simulate the operational behavior of the ultrasound flowmeter 10. To that end, the simulation program product is configured to perform a method 200 for simulating the operational behavior of the ultrasound flowmeter 10. The simulation program product 60 comprises a digital twin of the ultrasound flowmeter 10 and a data interface 65, through which it is connected to the ultrasound flowmeter 10. The simulation program product 60 is configured to receive any form of sensor data from sensors which belong to the ultrasound flowmeter 10, including the data 49 from the ultrasound receiver 14. The data interface 65 is embodied as an Application Programming Interface, also commonly referred to as an API. Based on the sensor data received through the data interface 65, the simulation program product 60 may detect a defect component of the ultrasound flowmeter 10 or an undue deterioration of the reception quality at the ultrasound receiver 14.

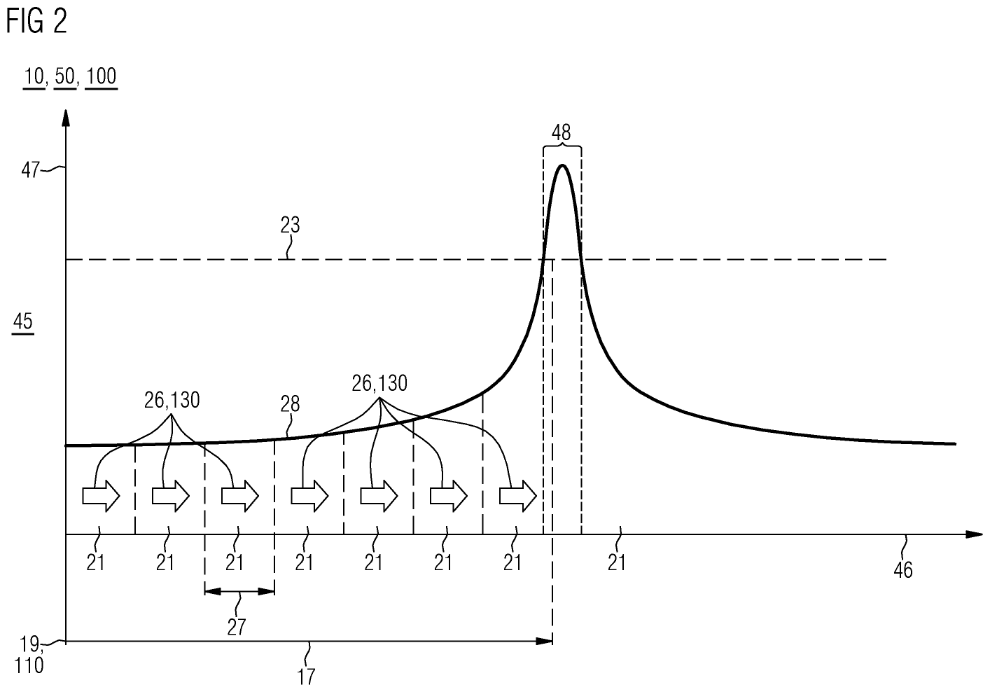

A second embodiment of the disclosed method 100 for operation an ultrasound flowmeter 10 is shown in FIG. 2. The second embodiment of the disclosed method 100 is performed at an ultrasound flowmeter 10 as shown in FIG. 1, for example. Furthermore, the second embodiment of the disclosed method 100 is shown based on a diagram 45 which comprises a horizontal time axis 46 and a magnitude axis 47. The magnitude axis 47 illustrates a magnitude of the reception quality parameter 28 that occurs at different positions 21 of the ultrasound receiver 14, i.e. at different distances between the ultrasound emitter 12 and the ultrasound receiver 14 of the ultrasound flowmeter 10. Since the ultrasound receiver 14 reaches different positions 21 in the course of the disclosed method 100, the time axis 46 in the diagram 45 also corresponds to a position axis.

The stage of the disclosed method 100 shown is FIG. 2 assumes that a first step 110, as shown in FIG. 1, for example, has been performed. Thus, the ultrasound receiver 14 has assumed at a starting position 19 before an ultrasound burst 20 is emitted for the first time. When an ultrasound burst 20 is emitted, the ultrasound receiver 14 receives a corresponding reflection 22 of the ultrasound burst 20. Based on that, the local control unit 42 determines the corresponding reception quality parameter 28 during the second step 120. Subsequent to that, the distance 17 between the ultrasound emitter 12 and the ultrasound receiver 14 is altered in the third step 130 of the disclosed method 100. Altering the distance 17 encompasses that the local control unit 42 transmits an instruction 41 to the driving means 16 of the ultrasound flowmeter 10. These steps are repeated to determine a plurality of values for the prediction quality parameter 28. In FIG. 2, the steps are symbolized by arrows pointing from one position 21 on the time axis 46 to another. The distance 17 between the ultrasound emitter 12 and the ultrasound receiver 14 is altered in steps with a width 27. The width 27 may be a predefined value or a variable value that may be adjusted by the computer program product 50 which is utilized to perform the disclosed method 100.

The steps described above are repeated until the reception quality parameter 28 reaches an optimized value 23. In the second embodiment of the disclosed method 100, the optimized value 23 is a minimum value, which delimit a portion of the curve that symbolizes the prediction quality parameter 28 that occurs at every possible distance 17 between the ultrasound emitter and the ultrasound receiver. The steps outlined above are repeated until the reception quality parameter 28 exceeds the optimized value 23. Once the reception quality parameter 28 exceeds the optimized value 23, the distance 17 between the ultrasound emitter 12 and the ultrasound receiver 14 is kept and the ultrasound flowmeter 10 may commence measuring operation. The optimized value 23 may be a predefined value or a variable value that may be adjusted through the computer program product 50. The second embodiment of the disclosed method 100 allows for finding a suitable distance 17 between the ultrasound emitter and the ultrasound receiver 14 quickly.

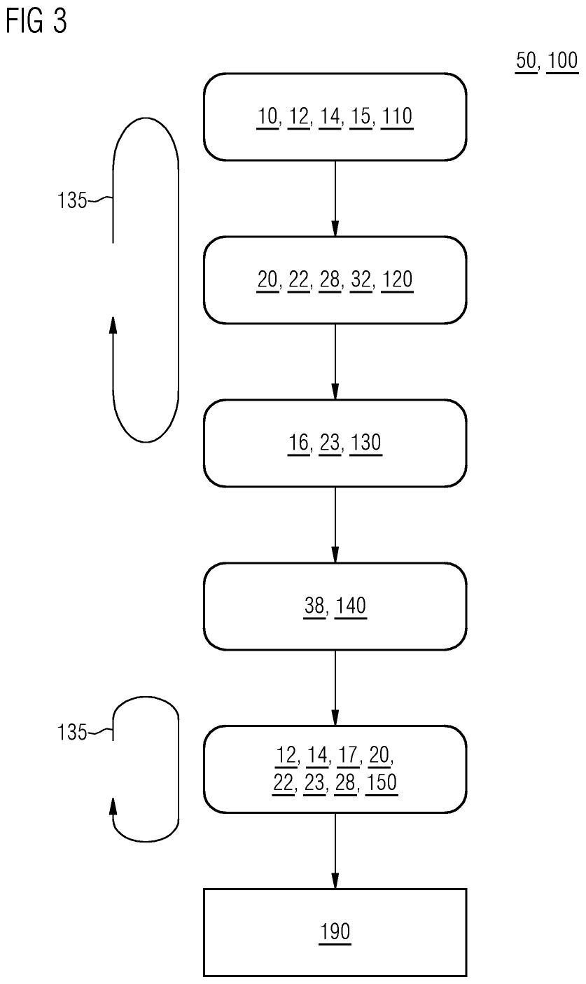

FIG. 3 shows a third embodiment of the disclosed method 100 for operating a ultrasound flowmeter 10 as a flow chart. The method 100 comprises a first step 110 in which the flowmeter 10 is provided and mounted to a pipe 30, where a flowrate 25 of a fluid 15 is to be determined, i.e. to be measured. The ultrasound flowmeter 10 comprises at least one ultrasound emitter 12 and at least one ultrasound receiver 14. At least one of the ultrasound emitter 12 and the ultrasound receiver 14 may each be embodied as an ultrasound transceiver. At least one of the ultrasound emitter 12 and the ultrasound receiver 14 are moveable to adjust a distance 17 between them. The ultrasound flowmeter 10 further comprises at least one driving means 16 for altering the distance 17 between the ultrasound emitter 12 and the ultrasound receiver 14. Additionally, the ultrasound flowmeter 10 comprises a control unit 40 that is connected to the ultrasound emitter, the ultrasound receiver 14 and the driving means 16. The control unit 40 may be connected to the ultrasound emitter 12, the ultrasound receiver 14 and the driving means 16 each direct or indirectly.

In the first step 110, at least one of the ultrasound emitter 12 and the ultrasound receiver 14 is put into a starting position 19. In second step 120 of the method 100, an ultrasound burst 20 is emitted from the ultrasound emitter 12. The ultrasound burst 20 may be substantially diagonally emitted into the pipe wall 32. A reflection 22 of the ultrasound burst 20 is received at the ultrasound receiver 14. Furthermore, a reception quality parameter 28 may be determined for the captured reflection 22 of the ultrasound burst 20. The quality parameter 28 may be determined by the control unit 40 of the ultrasound flowmeter 10. The disclosed method 100 also comprises a third step 130 in which the distance 17 between the ultrasound emitter 12 and the ultrasound receiver 14 is altered by actuating the driving means 16.

In the disclosed method 100, the steps of emitting the ultrasound burst 20, capturing the reflection 22 of the ultrasound burst 20, determining the reception quality parameter 28 and altering the distance 17 between the ultrasound emitter 12 and the ultrasound receiver 14 are repeated until the reception quality parameter 28 reaches an optimized value. In FIG. 3, that repetition is symbolized by the upper annular arrow 135. The optimized value 23 may be a maximum or a value that exceeds a predefined threshold value. When the optimized value 23 for the distance 17 between the ultrasound emitter 12 and the ultrasound receiver 14 is determined based on the steps outlined above, at least one of the ultrasound emitter 12 and the ultrasound receiver 14 may be are in their respective positions and a measuring operation of the ultrasound flowmeter 10 commences. At least the third step may be a computer-implemented step that may be performed based on a computer-program product 50 which runs on the control unit 40.

Furthermore, the disclosed method 100 comprises a fourth step 140 in which a temperature change of the fluid 15 in the pipe 30 is detected with a temperature sensor 38. The fourth step 140 also comprises determining if the detected temperature change exceeds a predefined threshold. The fourth step 140 may be performed as a computer-implemented step, for example by a computer program product 50 that is run on the control unit 40 of the ultrasound flowmeter 10. The method 100 according to FIG. 3 further comprises a fifth step 150 in which a re-calibration of the ultrasound flowmeter 10 is performed. The re-calibration is performed by emitting an ultrasound burst 20 from the ultrasound emitter 12 and by capturing a reflection 22 of the ultrasound burst 20 at the ultrasound receiver 14. The re-calibration also comprises determining a reception quality parameter 28 for the captured reflection 22 of the ultrasound burst 20 and altering the distance 17 between the ultrasound emitter 12 and the ultrasound receiver 14 by actuating the driving means 16.

The fifth step 150 is also performed based on the computer program product 50 that is run on the control unit 40 of the ultrasound flowmeter 10. The steps of emitting the ultrasound burst 20, capturing the reflection 22 of the ultrasound burst 20, determining the reception quality parameter 28 and altering the distance 17 between the ultrasound emitter 12 and the ultrasound receiver 14 are repeated until the reception quality parameter 28 reaches the optimized value 23 again. The optimized value 23 may be a maximum or a value that exceeds a threshold value. Based on the fourth and fifth step 140, 150, the underlying ultrasound flowmeter 10 is being re-calibrated during its operation. The fourth step 140 of the disclosed method 100 is automatically triggered by a detected event or a schedule to maintain an optimal calibration. That allows for operating the ultrasound flowmeter 10, and in turn an industrial process associated with the ultrasound flowmeter 10, at an increased efficiency without interference by a user. Thus, the method 100 according to FIG. 3 enhances the cost-effectiveness of the associated industrial process. After the fifth step 150, the method 100 for operating the ultrasound flowmeter 10 terminates and reaches a final state 190.

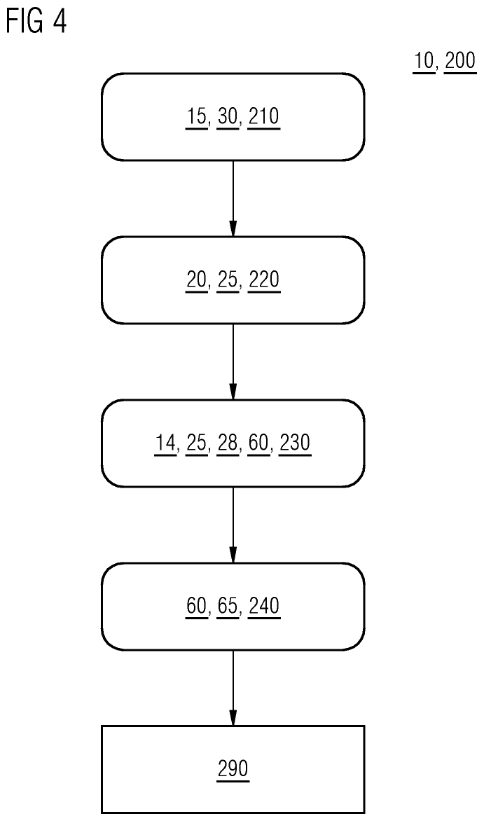

FIG. 4 shows an embodiment of the discloses method 200 for simulating an operational behavior of an ultrasound flowmeter 10. The method 200 comprises a first step 210 in which a set of data points is provided that mirror the functioning of at least a portion of the ultrasound flowmeter 10 that is simulated. The data points may be a digital model and may be part of a digital twin. The data points may mirror the physical design of at least one of the ultrasound flowmeter 10, a pipe 30 to which the ultrasound flowmeter 10 is attached, and a fluid 15 that is contained in the pipe 30. Alternatively, the data points may also comprise a mathematical model that emulates at least a functionality of any component of the emulated ultrasound flowmeter 10, i.e. the simulated ultrasound flowmeter 10. In a second step 220 of the disclosed method 200, at least one operational parameter is set. The at least one operational parameter may be any parameter that characterizes the operational state of the ultrasound flowmeter 10 that is to be simulated. The at least one operational parameter may comprise a structure of an ultrasound burst 20, a flow rate 25 of the fluid 15 in the pipe 30, a temperature of the fluid 15 in the pipe 30, an ambient temperature, and a composition of the fluid 15 in the pipe 30.

Furthermore, the at least one operational parameter may be set by at least one of a user and an algorithm that comprises artificial intelligence. In a third step 230 of the disclosed method 200, a simulation program product 60 is executed that is configured to emulate the operational behavior of the ultrasound flowmeter 10 based on the set of data points and the at least one operational parameter. Based on the set of data points and the at least one operational parameter, at least one performance parameter is determined through the simulation program product 60. The performance parameter may be any quantity that characterizes the operation of the emulated ultrasound flowmeter 10. The performance parameter may be at least one of a determined flow rate 25 of the fluid 15 in the pipe 30, a difference between the determined flow rate 25 of the fluid 15 and the flow rate 25 defined as an operational parameter, and a signal parameter derived from an emulated received reflection at the ultrasound receiver 14, i.e. the emulated ultrasound receiver 14.

The disclosed method 200 further comprises a fourth step 240, in which the at least one performance parameter is output to at least one of a user and a data interface 65. The data interface 65 may be configured to exchange simulations results from the simulation program product 65 with additional simulation-oriented computer program product. The data interface 65 may further be embodied as a so-called Application Programming Interface, or also known as an API. According to the disclosed method 200, the ultrasound flowmeter 10 that is emulated is embodied according to one of the embodiments outlined above. Thus, the features of the disclosed ultrasound flowmeter 10 also apply to the disclosed method for simulation an operational behavior.

The simulation program product 60 comprises a digital twin of the simulated ultrasound flowmeter 10. The simulation program product may be embodied as a digital twin pursuant to US 2017/0286572 A1. The simulation program product 60 further comprises a physics module that is configured to simulate a behavior of at least one of the components of the ultrasound flowmeter 10. The physics module may be configured to calculate the acoustic effects of at least one of the pipe wall 32 and the fluid 15 on the ultrasound burst 20 and the reflection 22 of the ultrasound burst as it propagates from the ultrasound emitter 12 to the ultrasound receiver 14. The physics module is configured to emulate the capturing characteristics of the ultrasound receiver 14. Among others, the method 200 shown in FIG. 4 is based on the finding that the acoustic effects of pipe walls 32 and fluids 15 may be precisely simulated even with reduced computing power. That includes a distorting and dissipating effect of the pipe wall 32 and of the fluid 15 onto the ultrasound burst 20 and its reflection 22. Such distorting and dissipating effects may also be caused by reflecting the ultrasound burst 20 and by its propagation through the fluid 15. Consequently, reception quality parameters 28 of the ultrasound flowmeter 10 may be predicted by the simulation program product 60. After the fourth step 240, the method 200 for simulating the operational behavior of the ultrasound flowmeter 10 is terminated.

1. An ultrasound flowmeter, comprising at least one ultrasound emitter and at least one ultrasound receiver, the ultrasound emitter being configured to emit an ultrasound burst, and the ultrasound receiver being configured to capture the ultrasound burst or a reflection of the ultrasound burst, the ultrasound receiver being connected to a control unit, the control unit being configured to determine a reception quality parameter based on the captured ultrasound burst or the captured reflection of the ultrasound burst, respectively, wherein at least one of the ultrasound emitter and the ultrasound receiver is connected to a driving means for altering a distance between them, the driving means being configured to cause at least one of the ultrasound emitter and the ultrasound receiver to move depending on the reception quality parameter.

2. The ultrasound flowmeter according to claim 1, wherein the reception quality parameter comprises at least one of an amplitude of the captured ultrasound burst or the reflection of the ultrasound burst, respectively, a parameter of a frequency component of the captured ultrasound burst or the captured reflection of the ultrasound burst, respectively, a signal-to-noise ratio of the captured ultrasound burst or the reflection of the ultrasound burst, respectively.

3. The ultrasound flowmeter according to claim 1, wherein the ultrasound burst comprises a selectable frequency composition.

4. The ultrasound flowmeter according to claim 1, wherein the control unit is configured to detect an optimized value of the reception quality parameter and to control the driving means to adjust the distance between the ultrasound emitter and the ultrasound receiver to a value corresponding to the detected optimized value.

5. The ultrasound flowmeter according to claim 1, wherein the control unit is configured to compare a determined value of the reception quality parameter to a previously determined value of the reception quality parameter.

6. The ultrasound flowmeter according to claim 1, wherein the ultrasound flowmeter comprises an energy storage that is configured to run at least the ultrasound emitter, the ultrasound receiver, the control unit and the driving means.

7. The ultrasound flowmeter according to claim 1, wherein the control unit is a local control unit or a remote control unit that is connected to the ultrasound flowmeter through a communication-capable data connection.

8. The ultrasound flowmeter according to claim 1, wherein the control unit is configured to determine a flow of a fluid in a pipe to which the ultrasound flowmeter is connected.

9. The ultrasound flowmeter according to claim 1, wherein the ultrasound flowmeter is connected to a temperature sensor, the temperature sensor being configured to detect a changing temperature of the fluid.

10. A method for operating an ultrasound flowmeter, the ultrasound flowmeter comprising at least one ultrasound emitter, at least one ultrasound receiver, at least one driving means for altering a distance between the ultrasound emitter and the ultrasound receiver, and a control unit connected to the ultrasound emitter, the ultrasound receiver and the driving means, the method comprising:
Mounting the ultrasound flowmeter to a wall of a pipe and putting at least one of the ultrasound emitter and the ultrasound receiver into a starting position;
Emitting an ultrasound burst from the ultrasound emitter, capturing the ultrasound burst or a reflection of the ultrasound burst at the ultrasound receiver, respectively, and determining a reception quality parameter for the captured ultrasound burst or the captured reflection of the ultrasound burst, respectively;
Altering the distance between the ultrasound emitter and the ultrasound receiver by actuating the driving means;
wherein the steps of emitting the ultrasound burst, capturing the ultrasound burst or the reflection of the ultrasound burst, determining the reception quality parameter and altering the distance between the ultrasound emitter and the ultrasound receiver are repeated until the reception quality parameter reaches an optimized value.

11. The method according to claim 10, wherein the reception quality parameter comprises at least one of an amplitude of the ultrasound burst or the reflection of the ultrasound burst, respectively, a parameter of a frequency component of the ultrasound burst or the reflection of the ultrasound burst, respectively, a signal-to-noise ratio of the ultrasound burst or the reflection of the ultrasound burst, respectively.

12. The method according to claim 10, wherein the method is performed independent of at least one of a diameter of the pipe, a wall thickness of the pipe and a material of the pipe.

13. The method according to claim 10, the method further comprising:
Detecting a temperature change of the fluid in the pipe with a temperature sensor and determining if the detected temperature change exceeds a predefined threshold;
Performing a re-calibration of the flowmeter by emitting an ultrasound burst from the ultrasound emitter, capturing the ultrasound burst or a reflection of the ultrasound burst at the ultrasound receiver, determining a reception quality parameter for the captured ultrasound burst or the captured reflection of the ultrasound burst, respectively, and altering the distance between the ultrasound emitter and the ultrasound receiver by actuating the driving means;
wherein the steps of emitting the ultrasound burst, capturing the ultrasound burst or the reflection of the ultrasound burst, determining the reception quality parameter and altering the distance between the ultrasound emitter and the ultrasound receiver are repeated until the reception quality parameter reaches an optimized value.

14. The method according to claim 10, wherein the method is performed while the fluid is flowing through the pipe.

15. A computer program product that is stored in a non-transitory memory, the computer program product comprising machine-readable program code, the machine-readable program code being configured to perform the following steps when loaded into the memory of a computer:
Actuating a driving means to cause at least one of an ultrasound emitter and an ultrasound receiver to assume a starting position;
Instructing the ultrasound emitter to emit an ultrasound burst, instructing the ultrasound receiver to capture the ultrasound burst or a reflection of the ultrasound burst and determining a reception quality parameter for the captured ultrasound burst or the captured reflection of the ultrasound burst, respectively;
Actuating the driving means to alter the distance between the ultrasound emitter and the ultrasound receiver;
wherein the steps of instructing the ultrasound emitter to emit the ultrasound burst, instructing the ultrasound receiver to capture the ultrasound burst or the reflection of the ultrasound burst, determining the reception quality parameter and instructing the driving means to alter the distance between the ultrasound emitter and the ultrasound receiver are repeated until the reception quality parameter reaches an optimized value.

16. A control unit configured to control an operation of an ultrasound flowmeter, the control unit comprising a memory and a processor, which are configured to execute a machine-readable program code of a computer program product, the control unit further comprising at least one communication interface configured for sending instructions to at least one of an ultrasound emitter, an ultrasound receiver and a driving means, the computer program product being embodied according to claim 15.

17. A method for simulating an operational behavior of an ultrasound flowmeter, the method comprising:
Providing a set of data points that mirror the functioning of at least a portion of the ultrasound flowmeter that is to be simulated;
Setting at least one operational parameter that defines the operational behavior that is to be simulated;
Executing a simulation program product that is configured to emulate the operational behavior of the ultrasound flowmeter based on the set of data points and the at least one operational parameter and determining at least one performance parameter;
Outputting the at least one performance parameter to a user and/or a data interface;
wherein the ultrasound flowmeter is embodied according to claim 1.

18. A simulation program product for simulating an operational behavior of an ultrasound flowmeter, wherein the operational behavior is simulated through a method according to claim 17.

19. The simulation program product according to claim 18, wherein the simulation program product comprises a data interface, the data interface being configured to connect the simulation program product to at least one of an ultrasound emitter, an ultrasound receiver and a driving means of an ultrasound flowmeter that is mirrored in the set of data points.

20. The simulation program product according to claim 19, wherein the data interface is embodied as an Application Programming Interface.
